(19) United States
(12) Patent Application Publication
(10) Pub. No.: US 2015/0027288 A1
(43) Pub. Date: Jan. 29, 2015

(54) BAND SAW MACHINE CAPABLE OF REGULATING BAND-SAW TENSION

(71) Applicant: National Chung Cheng University, Chia-Yi County (TW)

(72) Inventors: Yeau-Ren JENG, Tainan City (TW); Yu-Xian Huang, Tainan City (TW)

(73) Assignee: National Chung Cheng University, Chia-Yu County (TW)

(21) Appl. No.: 13/952,288

(22) Filed: Jul. 26, 2013

(51) Int. Cl. B23D 55/10

(52) U.S. Cl. CPC B23D 55/10
USPC 83/819

(57) ABSTRACT

A band saw machine includes a working bench, a driving wheel mounted to the working bench, a driven wheel mounted to the working bench, and a band saw running on the driving and driven wheels. A storage member and a hydraulic cylinder connected with the storage member are mounted to the working bench. The hydraulic cylinder includes a piston rod for pushing against the driven wheel to make the driven wheel tighten the band saw while moving relative to the driving wheel. A force sensor is mounted between the piston rod and the driven wheel for sensing the tension of the band saw and emitting a sensing signal to a control system. In this way, the control system can receive the sensing signal and controllably making the storage member supply oil to the cylinder body according to the sensing signal to force the piston rod to elongate.

### BACKGROUND OF THE INVENTION

1. Field of the Invention

The present invention relates generally to a band saw machine and more particularly, to a band saw machine capable of regulating band-saw tension.

2. Description of the Related Art

Before operating a band saw machine to cut a workpiece for processing, an operator needs to regulate the band saw for proper tension to keep the butting precision and prolong the service life of the band saw. For this reason, a lot of prior art for regulation of tension of the band saw has been proposed. For example, Taiwan Pat. Laid-open No. 200512055 disclosed that a hand wheel is employed to drive a piston rod to squeeze a liquid synchronously, while the band saw is tensioned, to make a tension meter detect how much the tension of the band saw is according to the pressure of compressed liquid. Besides, Taiwan Pat. No. M272656 disclosed that a telescopic rod of a hydraulic cylinder is employed to push a driven wheel to make the driven wheel move to further tighten the band saw. U.S. Pat. No. 5,557,989 disclosed that a screw bolt is rotated to move a stop member to make the stop member tighten or loosen the band saw for regulation of the band saw.

However, in each of aforesaid prior art, the regulation is manual and laborsome and troublesome in the process of the manual regulation because manual observation is needed to confirm whether the tension of the band saw has been properly adjusted during the whole process. In this way, the regulation is subject to impropriety resulting from personal oversight to further adversely affect the cutting precision and service life of the band saw.

### SUMMARY OF THE INVENTION

The primary objective of the present invention is to provide a band saw machine, which is capable of regulating band-saw tension to enhance the cutting precision and service life of the band saw.

The foregoing objective of the present invention is attained by the band saw machine formed of a working bench, a motor, a driving wheel, a driven wheel, a band saw, a tension regulation device, a force sensor, and a control system. The working bench includes a driving-wheel holder and a driven-wheel holder relative to the driving-wheel holder. The driven-wheel holder includes a slot. The motor is mounted to the working bench and includes a driving shaft for providing a power source. The driving wheel is mounted to the driving-wheel holder and connected with the driving shaft. The driven wheel is rotatably mounted in the driven-wheel holder. The band saw runs on the driving and driven wheels. The tension regulation device includes a slide member, a hydraulic cylinder, a storage member, and an oil tube. The slide member is slidably mounted in the slot and connected with the driven wheel. The hydraulic cylinder includes a cylinder body and a piston rod. The cylinder body is fixed to the driven-wheel holder. The piston rod includes two ends, one of which is mounted in the cylinder body and the other pushes against the slide member. The oil tube is connected with the storage member and the cylinder body. The force sensor is mounted between the slide member and the piston rod for sensing the tension of the band saw and emitting a sensing signal. The control system is connected with the storage member and the force sensor for receiving the sensing signal of the force sensor and controllably making the storage member supply oil to the cylinder body according to the sensing signal to force the piston rod to elongate.

In light of the structure, mentioned above, the band saw machine of the present invention can monitor the tension of the band saw in real time by means of the force sensor and make the sensed tension become a feedback to the control system and then the control system can control the length of the piston rod for adjusting the tension of the band saw, thus enhancing the cutting precision and service life of the band saw.

### BRIEF DESCRIPTION OF THE DRAWINGS

FIG. 1 is a plan view of a preferred embodiment of the present invention.

FIG. 2 is a perspective view of the force sensor in accordance with the preferred embodiment of the present invention.

FIG. 3 is a partially plan view of the preferred embodiment of the present invention, illustrating that the piston rod of the hydraulic cylinder has not pushed against the driven wheel.

FIG. 4 is similar to FIG. 3, illustrating that the piston rod of the hydraulic cylinder pushes against the driven wheel.

FIG. 5 is a block diagram of the preferred embodiment of the present invention.

### DETAILED DESCRIPTION OF PREFERRED EMBODIMENTS

Structural features and desired effects of the present invention will become more fully understood by reference to a preferred embodiment given hereunder. However, it is to be understood that the embodiments given by way of illustration only, thus is not imitative of the claim scope of the present invention.

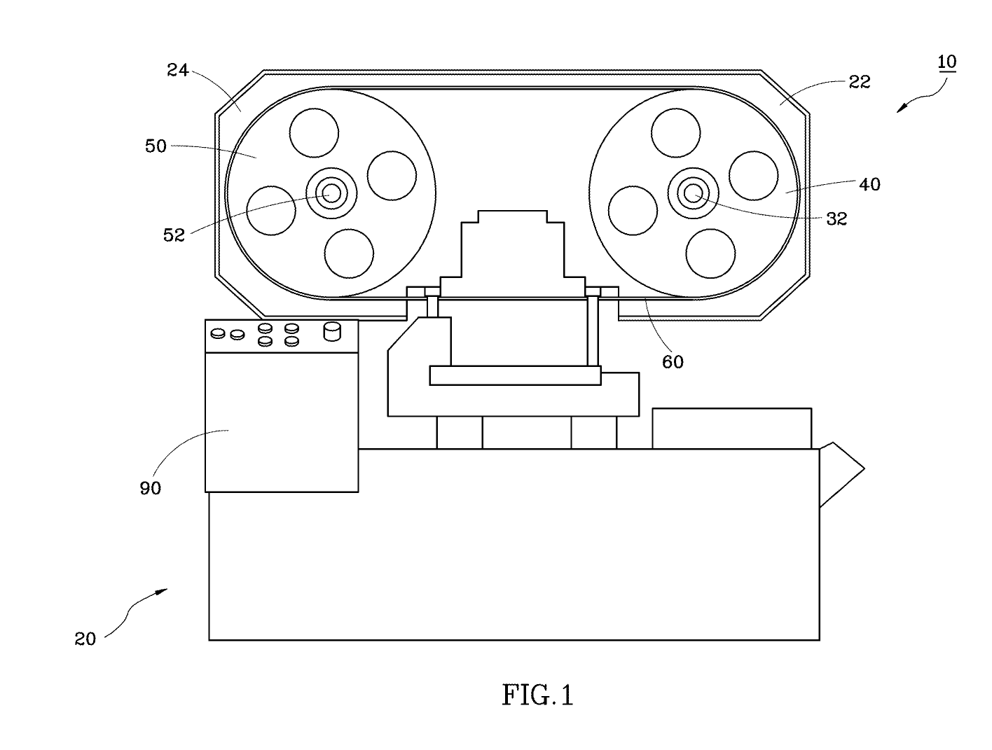

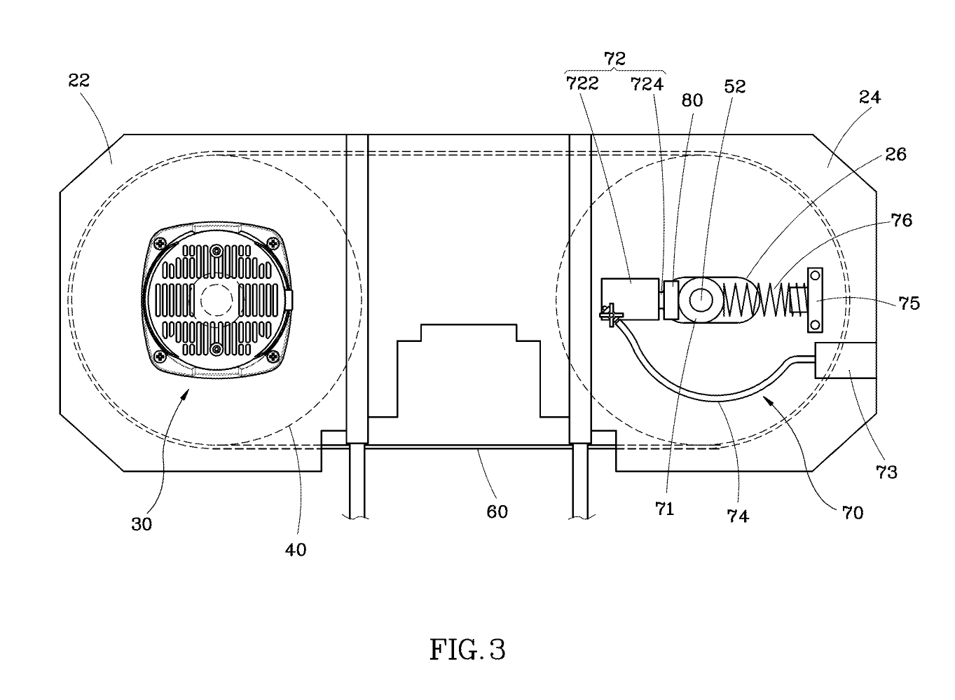

Referring to FIGS. 1, 3 & 4, a band saw machine 10 capable of regulating band-saw tension in accordance with a preferred embodiment of the present invention is formed of a working bench 20, a motor 30, a driving wheel 40, and a driven wheel 50, a band saw 60, a tension regulation device 70, a force sensor 80, and a control system 90. The detailed descriptions and operations of these elements as well as their interrelations are recited in the respective paragraphs as follows.

The working bench 20 includes a driving-wheel holder 22 and a driven-wheel holder 24 relative to the driving-wheel holder 22. The driven-wheel holder 24 includes a slot 26, as shown in FIG. 3.

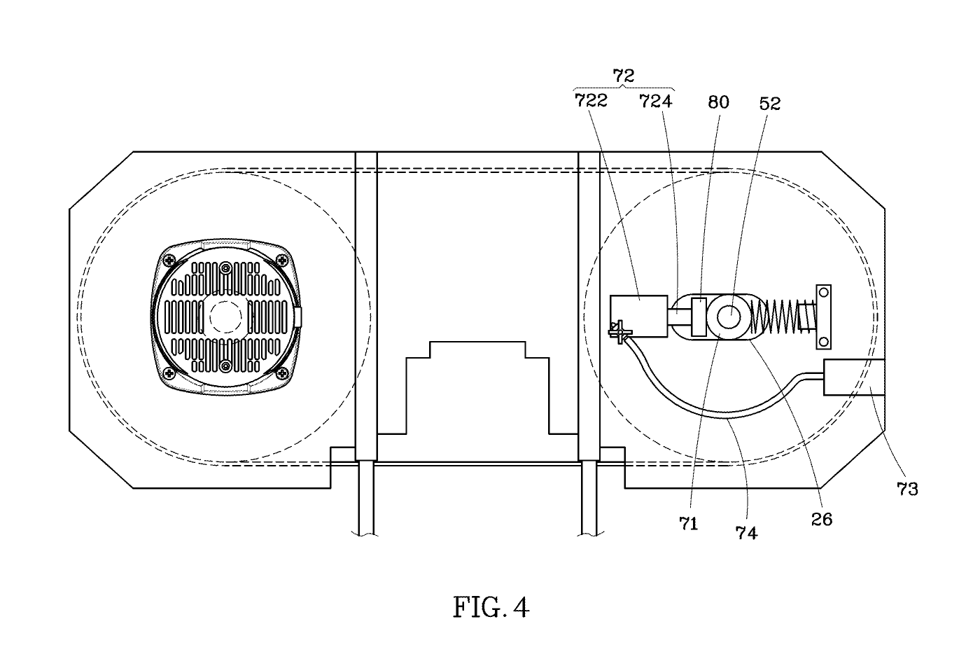

The motor 30 is installed to a backside of the driving wheel 22, as shown in FIG. 4, for providing a power source. The motor includes a driving shaft 42 extending into the driving-wheel holder 22, as shown in FIG. 1.

The driving wheel 40 is mounted inside the driving-wheel holder 22 and connected with the driving shaft 32. In this way, the driving wheel 40 can be driven by the motor 30 for rotation.

The driven wheel 50 is rotatably mounted to the driven-wheel holder 24 via a rotary shaft 52 relative to the driving wheel 40.

The band saw 60 runs on the driving wheel 40 and the driven wheel 50 for cutting a workpiece (not shown).

The tension regulation device 70 includes a slide member 71, a hydraulic cylinder 72, a storage member 73, and an oil tube 74. The slide member 71 is slidably mounted in the slot 26 and connected with the rotary shaft 52. The hydraulic cylinder 72 includes a cylinder body 722 and a piston rod 724, as shown in FIGS. 3 and 4. The cylinder body 722 is fixed to a backside of the driven-wheel holder 24. The piston rod 724 includes two ends, one of which is mounted into the cylinder body 722 and the other can elongate to push against the slide member 71 to make the driven wheel 50 move along the slot 26 relative to the driving wheel 40 via the slide member 71 for tightening or loosening the band saw 60 in the process of movement of the driven wheel 50. The storage member 73 is fixed to the backside of the driven-wheel holder 24 for storage of hydraulic oil (not shown). The oil tube 74 is connected between the storage member 73 and the cylinder body 722 for transmission of the hydraulic oil from the storage member 73 to the cylinder body 722 and when the hydraulic oil is supplied to the cylinder body 722, the piston rod 724 is forced to elongate. Besides, the tension regulation device 70 further includes a stop member 75 and a resilient member 76. The stop member 75 is fixed to the backside of the driven-wheel holder 24. The resilient member 76 is mounted between the slide member 71 and the stop member 75 can push the slide member 71 to make the driven wheel 50 pushed toward the hydraulic cylinder 72 for conveniently loosening the band saw 60.

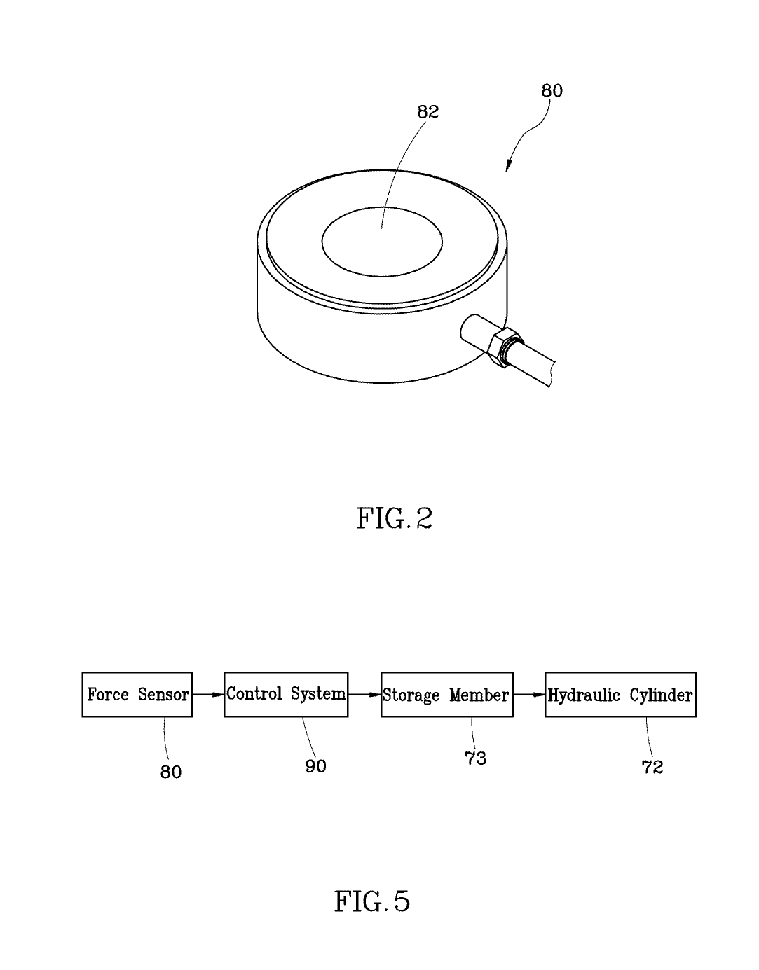

The force sensor 80 is a load cell in this preferred embodiment and stopped against the slide member 71. The force sensor 80 includes a bearing hole 82, as shown in FIG. 2, sleeved onto the piston rod 724 to make the force sensor 80 located between the slide member 71 and the piston rod 724 for sensing forced deformation of the slide member 71 and emitting a sensing signal.

The control system 90 is fixed to the working bench 20 and connected with the storage member 73 and the force sensor 80, as shown in FIG. 3-5, for controllably making the storage member 73 supply the hydraulic oil to the cylinder body 722.

In light of the structure mentioned above, when the driving wheel 40 is driven the motor 30 for rotation, the band saw 60 can be towed for synchronous rotation and then keep running on the driving wheel 40 and the driven wheel 50 to cut the workpiece. In the process of cutting the workpiece, as shown in FIGS. 3 and 4, the tension of the band saw 60 can be transmitted to the slide member 71 via the rotary shaft 52 and meanwhile, the force sensor 70 can sense the forced deformation of the slide member 71 to emit a sensing signal to the control system 80. Once the tension of the band saw 60 is evidently insufficient, the control system 90 can control the storage member 73 for supplying the hydraulic oil to the cylinder body 722 to force the piston rod 724 to elongate gradually to further push the slide member 71 to make the driven wheel 50 move away from the driving wheel 40. When the tension of the band saw 60 is adjusted properly, the control system 90 can control the storage member 73 for stopping the supply of the hydraulic oil.

In conclusion, the band saw machine 10 of the present invention can monitor the tension of the band saw 60 in real time by means of the force sensor 80 and the control system 90 can adjust the tension of the band saw 60 by controlling the length of the piston rod 724. In this way, the cutting precision and service life of the band saw 60 can be enhanced to reach the purpose of the present invention.

What is claimed is:

1. A band saw machine comprising:
a working bench having a driving-wheel holder and a driven-wheel holder relative to the driving-wheel holder, the driven-wheel holder having a slot;
a motor mounted to the working bench and having a rotary shaft;
a driving wheel mounted inside the driving-wheel holder of the working bench and connected with the rotary shaft for making the driving wheel be driven by the motor for rotation;
a driven wheel rotatably mounted inside the driven-wheel holder of the Working bench;
a band saw running on the driving wheel and the driven wheel;
a tension regulation device having a slide member, a hydraulic cylinder, a storage member, and an oil tube, the slide member being slidably mounted in the slot of the driven-wheel holder and connected with the driven wheel, the hydraulic cylinder having a cylinder body and a piston rod, the cylinder body being fixed to the driven-wheel holder, the piston rod having two ends, one of which is mounted to the cylinder body and the other pushes against the slide member, the oil tube being connected with the storage member and the cylinder body for supplying the hydraulic oil to the cylinder from the storage member;
a force sensor mounted between the slide member and the piston end of the hydraulic cylinder for sensing the tension of the band saw and emitting a sensing signal; and
a control system connected with the storage member and the force sensor for receiving the sensing signal from the force sensor and controllably making the storage member supply the hydraulic oil to the cylinder body of the hydraulic cylinder according to the sensing signal to elongate the piston rod.

2. The band saw machine as defined in claim 1, wherein the force sensor is stopped against the slide member and comprises a bearing hole, the bearing hole being sleeved onto the piston rod of the hydraulic cylinder.

3. The band saw machine as defined in claim 1, wherein the tension regulation device further comprises a stop member and a resilient member, the stop member being fixed to the driven-wheel holder, the resilient member being mounted between the slide member and the stop member for pushing the driven wheel toward the hydraulic cylinder.

4. The band saw machine as defined in claim 1, wherein the driven wheel is mounted inside the driven wheel holder via a rotary shaft, the rotary shaft being connected with the slide member.

5. The band saw machine as defined in claim 1, wherein the storage member is fixed to the driven-wheel holder.
